(19) United States
(12) Patent Application Publication
(10) Pub. No.: US 2006/0044204 A1
(43) Pub. Date: Mar. 2, 2006

(54) Phased array antenna with steerable null

(76) Inventor: Jeffrey Kruth, Ellicott City, MD (US)

Correspondence Address: James S. Finn;C/O William Tucker, Box #8, 14431 Goliad Dr., Malakoff, TX, 75148, US

(21) Appl. No.: 11/202,923

(22) Filed: Aug. 13, 2005

Related U.S. Application Data
(60) Provisional application No. 60/601,430, filed on Aug. 14, 2004.

(51) Int. Cl. H01Q 21/08

(52) U.S. Cl. 343/824

(57) ABSTRACT

An embodiment of the present invention provides an apparatus, comprising an array of patch antennas and a switch/phase shifter network capable of combining the patch antennas in a selected sequential group and wherein by stepping the group throughout the patch antennas, a plurality of main beam positions can be created with at least one of the main beam positions capable of being active with the remaining main beam positions idle, and wherein by sampling energy from the remaining idle antenna elements, a second beam is formed that is capable of creating a null signal in the direction of the second beam. In an embodiment of the present invention, the array of patch antennas may be a circular array and the stepping the group around the array is stepping the group around a circumference of the circular array of patch antennas.

### CROSS REFERENCE TO RELATED PATENT APPLICATION

This application claims the benefit of U.S. Provisional Patent Application No. 60/601,430, filed Aug. 14, 2004, entitled, “PHASED ARRAY ANTENNA WITH STEERABLE NULL”.

### BACKGROUND OF THE INVENTION

Wireless communication has become pervasive and important throughout society. There are constant needs for improvement in wireless devices that facilitate such communication. One important difficulty with wireless communication can be interference, which creates a requirement for communication directional control and interference mitigation. Thus, a strong need exists for wireless devices and communication methods that may use phased array antennas with steerable nulls.

### SUMMARY OF THE INVENTION

An embodiment of the present invention provides an apparatus, comprising an array of patch antennas and a switch/phase shifter network capable of combining the patch antennas in a selected sequential group and wherein by stepping the group throughout the patch antennas, a plurality of main beam positions can be created with at least one of the main beam positions capable of being active with the remaining main beam positions idle, and wherein by sampling energy from the remaining idle antenna elements, a second beam is formed that is capable of creating a null signal in the direction of the second beam.

In an embodiment of the present invention, the array of patch antennas may be a circular array and the stepping the group around the array may be stepping the group around a circumference of the circular array of patch antennas. Further, the antenna with a circularly disposed array of patch antennas may be a circularly disposed array of nine microstrip patch antennas having vertical polarization and dual outputs and the first and second beam may be implemented by use of a directional coupler. When three of the nine microstrip elements are in use, six elements may be idle and by sampling energy from the six idle antenna elements, a second beam can be formed and by using a second beamformer, a steerable secondary beam may be created. In an embodiment of the present invention, by inverting the polarity of the second beam and adding it to the main beam with a predetermined amplitude weighting, destructive interference in the direction of the second beam may occur and the second beam may be effectively subtracted from the first beam, thereby creating a null in the direction of the second beam. In an embodiment of the present invention, a circularly disposed array of patch antennas may be connected to a receiver controlled by a controller which is capable of time-shared transmission and reception. Also, an embodiment of the present invention may further comprise a table of azimuth angle versus power level made by using an RSSI level and wherein a prioritization may be used to allocate a null to a most likely interferer and once the null signal has been selected, the azimuth angle for the null steer beam may be set in the switch/phase shifter matrix.

Yet another embodiment of the present invention provides a method of creating a steerable null in a phased array antenna, comprising disposing an array of patch antennas within a receiver, combining the patch antennas by a switch/phase shifter network into a selected sequential group and stepping the group through the patch antennas thereby creating a plurality of main beam positions with at least one of the main beam positions capable of being active with the remaining main beam positions idle, and sampling energy from the remaining idle antenna elements in order to form a second beam that is capable of creating a null signal in the direction of the second beam. In an embodiment of the present invention, the null may be generated on the strongest undesirable emitter by: setting the main beam azimuth, setting the null beam azimuth, measuring the RSSI, and manipulating the switch/phase shifter to minimize energy in the null beam azimuth.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 is a block diagram of one embodiment of the present invention; and

FIG. 2 illustrates a flow chart of the method of one embodiment of the present invention.

### DESCRIPTION OF THE PREFERRED EMBODIMENT

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

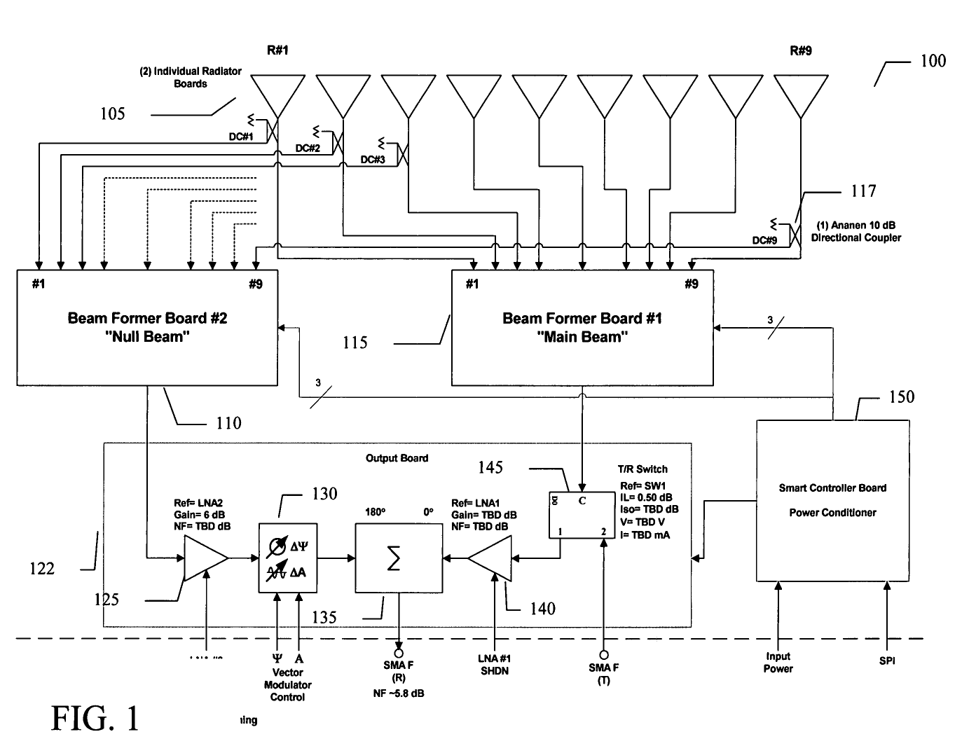

An embodiment of the present invention provides at FIG. 1 a “steerable null” for a 360 degrees phased array antenna (PAA) 100, although the present invention is not limited to specific radius of performance. The PAA 100 may use a circularly disposed array of nine microstrip patch antennas 105, having vertical polarization and dual outputs. The dual output may be implemented by use of directional couplers, DC 1-9 illustrated generally as 117, to sample energy from the element without taking too large a quantity from a main beam 115.

A special switch/phase shifter network 122 may combine these patches in a selected sequential group of 3-of-9. Included in switch/phase shifter network 122 may be low noise amplifier 140 receiving the output of transmit/receive switch 145 which received input from main beam 115 and passing to summation 135. Also input into summation 135 is the output of vector modulator control 130 which received as its input the output of low noise amplifier 125. Low noise amplifier 125 receives as its input the output of null beam 110.

By stepping this group around the circumference of the antenna by switch setting, nine main beam positions may be created, each group having a nominal 40 degree field of view, although the present invention is not limited in this respect. Movement between the fixed 40 degree center points may be accomplished by variation of three beam-squint phase shifters. Although not limited in this respect, the phase shifters may use voltage tunable dielectric material to facilitate their operation. This voltage tunable dielectric material may be Parascan® voltage tunable dielectric material. The term Parascan® as used herein is a trademarked term indicating a tunable dielectric material developed by the assignee of the present invention. Parascan® tunable dielectric materials have been described in several patents. Barium strontium titanate (BaTiO3-SrTiO3), also referred to as BSTO, is used for its high dielectric constant (200-6,000) and large change in dielectric constant with applied voltage (25-75 percent with a field of 2 Volts/micron). Tunable dielectric materials including barium strontium titanate are disclosed in U.S. Pat. No. 5,312,790 to Sengupta, et al. entitled “Ceramic Ferroelectric Material”; U.S. Pat. No. 5,427,988 by Sengupta, et al. entitled “Ceramic Ferroelectric Composite Material-BSTO-MgO”; U.S. Pat. No. 5,486,491 to Sengupta, et al. entitled “Ceramic Ferroelectric Composite Material—BSTO-ZrO2”; U.S. Pat. No. 5,635,434 by Sengupta, et al. entitled “Ceramic Ferroelectric Composite Material-BSTO-Magnesium Based Compound”; U.S. Pat. No. 5,830,591 by Sengupta, et al. entitled “Multilayered Ferroelectric Composite Waveguides”; U.S. Pat. No. 5,846,893 by Sengupta, et al. entitled “Thin Film Ferroelectric Composites and Method of Making”; U.S. Pat. No. 5,766,697 by Sengupta, et al. entitled “Method of Making Thin Film Composites”; U.S. Pat. No. 5,693,429 by Sengupta, et al. entitled “Electronically Graded Multilayer Ferroelectric Composites”; U.S. Pat. No. 5,635,433 by Sengupta entitled “Ceramic Ferroelectric Composite Material BSTO-ZnO”; U.S. Pat. No. 6,074,971 by Chiu et al. entitled “Ceramic Ferroelectric Composite Materials with Enhanced Electronic Properties BSTO Mg Based Compound-Rare Earth Oxide”. These patents are incorporated herein by reference. The materials shown in these patents, especially BSTO-MgO composites, show low dielectric loss and high tunability. Tunability is defined as the fractional change in the dielectric constant with applied voltage.

Barium strontium titanate of the formula BaxSr1-xTiO3 is a preferred electronically tunable dielectric material due to its favorable tuning characteristics, low Curie temperatures and low microwave loss properties. In the formula BaxSr1-xTiO3, x can be any value from 0 to 1, preferably from about 0.15 to about 0.6. More preferably, x is from 0.3 to 0.6.

Other electronically tunable dielectric materials may be used partially or entirely in place of barium strontium titanate. An example is BaxCa1-xTiO3, where x is in a range from about 0.2 to about 0.8, preferably from about 0.4 to about 0.6. Additional electronically tunable ferroelectrics include PbxZr1-xTiO3 (PZT) where x ranges from about 0.0 to about 1.0, PbxZr1-xSrTiO3 where x ranges from about 0.05 to about 0.4, KTaxNb1-xO3 where x ranges from about 0.0 to about 1.0, lead lanthanum zirconium titanate (PLZT), PbTiO3, BaCaZrTiO3, NaNO3, KNbO3, LiNbO3, LiTaO3, PbNb2O6, PbTa2O6, KSr(NbO3) and NaBa2(NbO3)5KH2PO4, and mixtures and compositions thereof. Also, these materials can be combined with low loss dielectric materials, such as magnesium oxide (MgO), aluminum oxide (Al2O3), and zirconium oxide (ZrO2), and/or with additional doping elements, such as manganese (MN), iron (Fe), and tungsten (W), or with other alkali earth metal oxides (i.e. calcium oxide, etc.), transition metal oxides, silicates, niobates, tantalates, aluminates, zirconnates, and titanates to further reduce the dielectric loss.

In addition, the following U.S. patent applications, assigned to the assignee of this application, disclose additional examples of tunable dielectric materials: U.S. application Ser. No. 09/594,837 filed Jun. 15, 2000, entitled “Electronically Tunable Ceramic Materials Including Tunable Dielectric and Metal Silicate Phases”; U.S. application Ser. No. 09/768,690 filed Jan. 24, 2001, entitled “Electronically Tunable, Low-Loss Ceramic Materials Including a Tunable Dielectric Phase and Multiple Metal Oxide Phases”; U.S. application Ser. No. 09/882,605 filed Jun. 15, 2001, entitled “Electronically Tunable Dielectric Composite Thick Films And Methods Of Making Same”; U.S. application Ser. No. 09/834,327 filed Apr. 13, 2001, entitled “Strain-Relieved Tunable Dielectric Thin Films”; and U.S. Provisional Application Ser. No. 60/295,046 filed Jun. 1, 2001 entitled “Tunable Dielectric Compositions Including Low Loss Glass Frits”. These patent applications are incorporated herein by reference.

The tunable dielectric materials can also be combined with one or more non-tunable dielectric materials. The non-tunable phase(s) may include MgO, MgAl2O4, MgTiO3, Mg2SiO4, CaSiO3, MgSrZrTiO6, CaTiO3, Al2O3, SiO2 and/or other metal silicates such as BaSiO3 and SrSiO3. The non-tunable dielectric phases may be any combination of the above, e.g., MgO combined with MgTiO3, MgO combined with MgSrZrTiO6, MgO combined with Mg2SiO4, MgO combined with Mg2SiO4, Mg2SiO4 combined with CaTiO3 and the like.

Additional minor additives in amounts of from about 0.1 to about 5 weight percent can be added to the composites to additionally improve the electronic properties of the films. These minor additives include oxides such as zirconnates, tannates, rare earths, niobates and tantalates. For example, the minor additives may include CaZrO3, BaZrO3, SrZrO3, BaSnO3, CaSnO3, MgSnO3, Bi2O3/2SnO2, Nd2O3, Pr7O11, Yb2O3, Ho2O3, La2O3, MgNb2O6, SrNb2O6, BaNb2O6, MgTa2O6, BaTa2O6 and Ta2O3.

Thick films of tunable dielectric composites may comprise Ba1-xSrxTiO3, where x is from 0.3 to 0.7 in combination with at least one non-tunable dielectric phase selected from MgO, MgTiO3, MgZrO3, MgSrZrTiO6, Mg2SiO4, CaSiO3, MgAl2O4, CaTiO3, Al2O3, SiO2, BaSiO3 and SrSiO3. These compositions can be BSTO and one of these components, or two or more of these components in quantities from 0.25 weight percent to 80 weight percent with BSTO weight ratios of 99.75 weight percent to 20 weight percent.

The electronically tunable materials may also include at least one metal silicate phase. The metal silicates may include metals from Group 2A of the Periodic Table, i.e., Be, Mg, Ca, Sr, Ba and Ra, preferably Mg, Ca, Sr and Ba. Preferred metal silicates include Mg2SiO4, CaSiO3, BaSiO3 and SrSiO3. In addition to Group 2A metals, the present metal silicates may include metals from Group 1A, i.e., Li, Na, K, Rb, Cs and Fr, preferably Li, Na and K. For example, such metal silicates may include sodium silicates such as Na2SiO3 and NaSiO3-5H2O, and lithium-containing silicates such as LiAlSiO4, Li2SiO3 and Li4SiO4. Metals from Groups 3A, 4A and some transition metals of the Periodic Table may also be suitable constituents of the metal silicate phase. Additional metal silicates may include Al2Si2O7, ZrSiO4, KalSi3O8, NaAlSi3O8, CaAl2Si2O8, CaMgSi2O6, BaTiSi3O9 and Zn2SiO4. The above tunable materials can be tuned at room temperature by controlling an electric field that is applied across the materials.

In addition to the electronically tunable dielectric phase, the electronically tunable materials can include at least two additional metal oxide phases. The additional metal oxides may include metals from Group 2A of the Periodic Table, i.e., Mg, Ca, Sr, Ba, Be and Ra, preferably Mg, Ca, Sr and Ba. The additional metal oxides may also include metals from Group 1A, i.e., Li, Na, K, Rb, Cs and Fr, preferably Li, Na and K. Metals from other Groups of the Periodic Table may also be suitable constituents of the metal oxide phases. For example, refractory metals such as Ti, V, Cr, Mn, Zr, Nb, Mo, Hf, Ta and W may be used. Furthermore, metals such as Al, Si, Sn, Pb and Bi may be used. In addition, the metal oxide phases may comprise rare earth metals such as Sc, Y, La, Ce, Pr, Nd and the like.

The additional metal oxides may include, for example, zirconnates, silicates, titanates, aluminates, stannates, niobates, tantalates and rare earth oxides. Preferred additional metal oxides include Mg2SiO4, MgO, CaTiO3, MgZrSrTiO6, MgTiO3, MgAl2O4, WO3, SnTiO4, ZrTiO4, CaSiO3, CaSnO3, CaWO4, CaZrO3, MgTa2O6, MgZrO3, MnO2, PbO, Bi2O3 and La2O3. Particularly preferred additional metal oxides include Mg2SiO4, MgO, CaTiO3, MgZrSrTiO6, MgTiO3, MgAl2O4, MgTa2O6 and MgZrO3.

The additional metal oxide phases are typically present in total amounts of from about 1 to about 80 weight percent of the material, preferably from about 3 to about 65 weight percent, and more preferably from about 5 to about 60 weight percent. In one preferred embodiment, the additional metal oxides comprise from about 10 to about 50 total weight percent of the material. The individual amount of each additional metal oxide may be adjusted to provide the desired properties. Where two additional metal oxides are used, their weight ratios may vary, for example, from about 1:100 to about 100:1, typically from about 1:10 to about 10:1 or from about 1:5 to about 5:1. Although metal oxides in total amounts of from 1 to 80 weight percent are typically used, smaller additive amounts of from 0.01 to 1 weight percent may be used for some applications.

The additional metal oxide phases can include at least two Mg-containing compounds. In addition to the multiple Mg-containing compounds, the material may optionally include Mg-free compounds, for example, oxides of metals selected from Si, Ca, Zr, Ti, Al and/or rare earths.

It can be seen that at any time, only three of the nine microstrip elements may be in use. This leaves six elements idle. By sampling energy from the six idle antenna elements, a second beam 110 may be formed. Using a second beamformer, a completely steerable secondary beam may be created.

The goal of creating a second beam is to allow interferers to be located that are not on the axis of the main (primary communications) beam 115. This allows an electronic intelligence (ELINT) capability. By inverting the polarity of this signal so created, and adding it to the main beam 115 (with proper amplitude weighting), destructive interference in the direction of the second beam 110 will occur. This effectively subtracts the second beam 110 from the first 115, creating a null in the direction of the second beam 110, providing an Electronic Counter-Countermeasures (ECCM) capability. The null depth achieved is a function of the quality of the vector subtraction performed. In turn, this is a function of the setting of the relative phase and amplitude of the energy in the second beam compared to the first.

The process for using the null steer array may use a sensitive detector, such as a system receiver, to acquire the emitter signal. This is true of either beam. In order to reduce the effect of jammers (intentional or otherwise), locating emitters and steering the second beam onto them may be performed. In order to do this, a receiver must either be time-shared with the communications function or a second receiver must be added to the system. A controller 150 may also be required for this receiver, as it must be just as flexible as the primary receiver as far a frequency range, speed, etc. is concerned. Due to size, weight, prime power, cost constraints, etc. a second receiver is less desirable. Since most systems do not use a main receiver 100% of the time, a secondary mission that time shares the receiver may be implemented. This would be to use the receiver as a sensor to identify the azimuth angles that have possible jammers on them. A jammer or “qualified” emitter is one whose power level as received at the PAA exceeds a predetermined threshold, and whose frequency is on channel or very close. A table of azimuth angle versus power level may be made using the Received Signal Strength Indicator (RSSI) level. A prioritization may be used to allocate the null to the most likely interferer. Once this signal has been selected, the azimuth angle for the null steer beam may be set in the switch/phase shifter matrix. Then the subtraction may be performed and the null vector phase and amplitude is “dithered” in a confined manner to attempt to minimize the resultant power as sensed at the receiver. Since the beam angle for the null may be restricted to lie outside the main beam, in an embodiment of the present invention, the closest the null may come is +−45 degrees to the main beam axis.

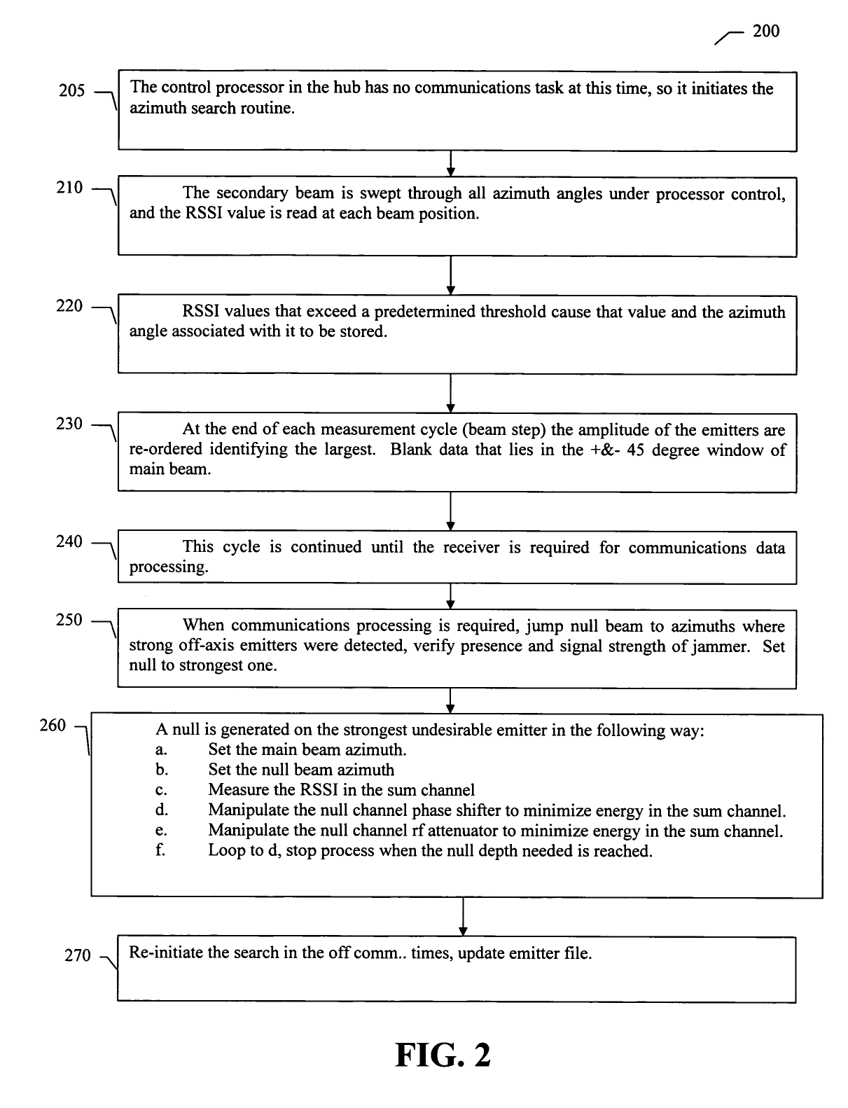

Turning now to FIG. 2, shown generally at 200, is a flowchart of the method of one embodiment of the present invention. At 25, the control processor in the hub has no communications task at this time, so it initiates the azimuth search routine and at 210 the secondary beam is swept through all azimuth angles under processor control, and the RSSI value is read at each beam position. At 220, RSSI values that exceed a predetermined threshold cause that value and the azimuth angle associated with it to be stored and at 230 at the end of each measurement cycle (beam step) the amplitude of the emitters are re-ordered identifying the largest. Blank data that lies in the +&−45 degree window of main beam. At 240 this cycle is continued until the receiver is required for communications data processing. When communications processing is required, at 250 jump the null beam to azimuths where strong off-axis emitters were detected and verify presence and signal strength of jammer and set null to strongest one.

Thereafter, at 260 a null is generated on the strongest undesirable emitter in the following way:

a. Set the main beam azimuth.

b. Set the null beam azimuth

c. Measure the RSSI in the sum channel

d. Manipulate the null channel phase shifter to minimize energy in the sum channel.

e. Manipulate the null channel radio frequency (RF) attenuator to minimize energy in the sum channel.

f. Loop to d, stop process when the null depth needed is reached.

Finally, at 270 re-initiate the search in the off communication period and update an emitter file.

While the present invention has been described in terms of what are at present believed to be its preferred embodiments, those skilled in the art will recognize that various modifications to the disclose embodiments can be made without departing from the scope of the invention as defined by the following claims.

What is claimed is:

1. An apparatus, comprising:
an array of patch antennas;
a switch/phase shifter network capable of combining said patch antennas in a selected sequential group and wherein by stepping said group throughout said patch antennas, a plurality of main beam positions can be created with at least one of said main beam positions capable of being active with the remaining main beam positions idle; and
wherein by sampling energy from said remaining idle antenna elements, a second beam is formed that is capable of creating a null signal in the direction of said second beam.

2. The apparatus of claim 1, wherein said array of patch antennas is a circular array and said stepping said group around said array is stepping said group around a circumference of said circular array of patch antennas.

3. The apparatus of claim 2, wherein said antenna with a circularly disposed array of patch antennas is a circularly disposed array of nine microstrip patch antennas having vertical polarization and dual outputs.

4. The apparatus of claim 3, wherein said first and second beam is implemented by use of a directional coupler.

5. The apparatus of claim 3, wherein when three of said nine microstrip elements are in use, six elements idle and by sampling energy from the six idle antenna elements, a second beam can be formed.

6. The apparatus of claim 4, wherein by using a second beamformer, a steerable secondary beam may be created.

7. The apparatus of claim 2, wherein the stepping said group around a circumference of said patch antennas is accomplished by variation of a three beam-squint phase shifters.

8. The apparatus of claim 2, wherein said circularly disposed array of nine microstrip patch creates a group three patch antennas having a nominal 40 degree field of view.

9. The apparatus of claim 5, wherein by inverting the polarity of said second beam and adding it to said main beam with a predetermined amplitude weighting, destructive interference in the direction of said second beam will occur.

10. The apparatus of claim 9, wherein said second beam is effectively subtracted from said first beam, thereby creating a null in the direction of said second beam.

11. The apparatus of claim 2, wherein said antenna with a circularly disposed array of patch antennas are connected to a receiver controlled by a controller which is capable of time-shared transmission and reception.

12. The apparatus of claim 2, further comprising a table of azimuth angle versus power level made by using an RSSI level and wherein a prioritization is used to allocate a null to a most likely interferer and once said null signal has been selected, the azimuth angle for said null steer beam is set in the switch/phase shifter matrix.

13. A method of creating a steerable null in a phased array antenna, comprising:
disposing an array of patch antennas within a receiver;
combining said patch antennas by a switch/phase shifter network into a selected sequential group and stepping said group through said patch antennas thereby creating a plurality of main beam positions with at least one of said main beam positions capable of being active with the remaining main beam positions idle; and
sampling energy from said remaining idle antenna elements in order to form a second beam that is capable of creating a null signal in the direction of said second beam.

14. The method of claim 13, wherein said array of patch antennas is a circular array and said stepping said group through said array is stepping said group around a circumference of said circular array of patch antennas.

15. The method of claim 13, wherein said circularly disposed array of patch antennas is a circularly disposed array of nine microstrip patch antennas having vertical polarization and dual outputs.

16. The method of claim 14, further comprising implementing said first and second beam by use of a directional coupler.

17. The method of claim 15, wherein when three of said nine microstrip elements are in use, six elements are idle and by sampling energy from said six idle antenna elements, a second beam can be formed.

18. The method of claim 15, further comprising initiating an azimuth search routine by a controller when said receiver is not active.

19. The method of claim 15, further comprising sweeping said second beam through all azimuth angles under processor control with an RSSI value read at each beam position.

20. The method of claim 19, wherein when said RSSI value exceeds a predetermined threshold, an azimuth angle associated with it is stored.

21. The method of claim 20, further comprising re-ordering at the end of each measurement cycle an amplitude of emitters to identify the largest.

22. The method of claim 19, further comprising continuing said sweeping until said receiver is required for communications data processing.

23. The method of claim 22, further comprising jumping said null beam to azimuths where strong off-axis emitters are detected when communications processing is required and verifying the presence and signal strength of jammers and setting said null signal to the strongest one.

24. The method of claim 14, wherein said null is generated on the strongest undesirable emitter by:
setting said main beam azimuth;
setting said null beam azimuth;
measuring the RSSI; and
manipulating said switch/phase shifter to minimize energy in the null beam azimuth.
